(19) United States
(12) Patent Application Publication
(10) Pub. No.: US 2008/0200603 A1
(43) Pub. Date: Aug. 21, 2008

(54) Paste Resins for Paints Containing Solvents

(75) Inventors: Gerald HOBISCH, Graz (AT); Peter MORRE, Graz (AT); Thomas SCHÖNBACHER, Kalsdorf (AT)

Correspondence Address: CONNOLLY BOVE LODGE & HUTZ, LLP, P O BOX 2207, WILMINGTON, DE, 19899, US

(73) Assignee: Cytec Surface Specialties Austria GmbH, Werndorf (AT)

(21) Appl. No.: 11/596,346

(22) PCT Filed: May 6, 2005
(86) PCT No.: PCT/EP05/04927

§ 371 Date: Jul. 9, 2007

(30) Foreign Application Priority Data
May 14, 2004 (EP) 04011533.9

(51) Int. Cl. C08L 61/00

(52) U.S. Cl. 524/542

(57) ABSTRACT

The invention relates to the use of urethane-modified hydrophilic resins ABCD as paste resins for paints containing solvents. The resins ABCD are conversion products of aldehyde resins or ketone resins A, of multifunctional isocyanates B with, on average, at least 2 isocyanate groups per molecule, of aliphatic acids C with at least one acid group and with at least one group that can react with isocyanates while forming a urethane structure or urea structure, and of aliphatic polyethers D with at least one hydroxyl group per molecule, whereby the sum of the mass proportions of educts A to D always equals 100%, and at least one of the educts C and D is used.

The invention relates to the use of urethane-modified hydrophilic resins as paste resins for solvent-borne coating materials.

Paste resins for solvent-borne coating materials are known from, for example, DE-C 22 18 613, which describes a reaction product of hydroxyl group-containing acrylic copolymers and carboxyl group-containing compounds which contain at least one pigment-dispersing group. These dispersing groups are selected for example from amino groups, beta-hydroxy ester groups, which form by reaction of a compound having a carboxyl group with an epoxide, and others, which are described in particular in German patent application DE-A 17 19 402.

Paste resins for aqueous systems are frequently derived from ammonium salts, sulfonium salts or from epoxide-amine adducts.

Those pigment dispersions that are described in the examples of DE-C 22 18 613 contain very high fractions of the dispersant, based on the mass of the pigments. This limits the utility of that teaching.

For the user of pigment dispersions it is awkward to have to store or prepare different preparations of pigments depending on whether the pigments are to be used in aqueous or in solvent-borne coating materials. An object which exists, therefore, is to provide pigment preparations which can be used equally in aqueous and in solvent-borne coating systems. It is likewise desired to use as small as possible an amount of the dispersant, based on the mass of the pigments. Surprisingly it has been found that certain reaction products of polymers containing acid groups with aldehyde resins or ketone resins, except for those uses as known from the prior art, as dispersants or paste resins in aqueous systems, can also be used as dispersants or paste resins for the pigmentation of solvent-borne coating materials.

The invention accordingly provides for the use, as dispersants for pigments in solvent-borne coating systems, of urethane-modified hydrophilic resins ABCD, obtainable by reacting mass fractions in the reaction mixture of
10% to 90% of aldehyde resins and/or ketone resins A having a hydroxyl number of from 20 mg/g to 300 mg/g, a softening temperature of from 60° C. to 140° C., and a number-average molar mass Mₙ of from 500 g/mol to 3000 g/mol,
5% to 30% of polyfunctional isocyanates B having an average of at least 2 isocyanate groups per molecule,
0% to 30% of aliphatic acids C having in each case at least one acid group and in each case at least one group which is able to react with isocyanates to form a urethane structure or urea structure, and
0% to 70% of an aliphatic polyether D having a number-average molar mass Mₙ of from 200 g/mol to 8000 g/mol and at least one hydroxyl group per molecule,
   the sum of the mass fractions of reactants A to D always being 100%, and at least one of reactants C and D being used.

The mass fractions in the reaction mixture are preferably from 35% to 85% for A, from 10% to 25% for B, from 2% to 10% for C, and from 5% to 30% for D; the mass fraction of C may be zero if at least one polyether D is employed, or the mass fraction of D may be zero if at least one of the acids C is employed.

The aldehyde resins and/or ketone resins A are not water-soluble; they are preferably resins which are obtainable by condensation of (cyclo)aliphatic oxo compounds A1, selected from (cyclo)aliphatic ketones A11 and aliphatic aldehydes A12, together with urea and/or its derivatives A2 (referred to below collectively as “ureas”).

Compounds considered urea derivatives A2 in the context of the present invention are N-alkylated, N-arylated or N-acylated ureas in which at least one and not more than 3 amidic hydrogen atoms have been substituted by an alkyl, aryl or acyl radical. Suitable alkyl radicals are linear, branched, and cyclic aliphatic radicals having from 1 to 20 carbon atoms; suitable aryl radicals are (unsubstituted or alkyl-substituted) aryl radicals having from 5 to 14 carbon atoms, such as the phenyl, naphthyl, o-tolyl or (p-phenyl)phenyl radical. The acyl radicals may be understood as radicals R—CO—, in which R may have the definition of the alkyl and aryl radicals mentioned here. It is of course also possible for the amidic hydrogen atoms to carry different substituents of the stated kind. Likewise suitable are urea derivatives in which an alkylene radical having from 2 to 4 carbon atoms joins the different nitrogen atoms to one another, such as ethyleneurea and propyleneurea (2-imidazolidone or tetrahydro-2-pyrimidone), for example, and their alkyl, acyl, and aryl derivatives, with likewise at least one amidic hydrogen atom being retained.

The aldehyde resins and ketone resins A are, as already observed, obtainable by condensation of ketones together with aldehydes and ureas, of ketones with ureas or of aldehydes with ureas, and preferably have a hydroxyl number of from 20 mg/g to 300 mg/g, a softening point of from 60° C. to 140° C., and a number-average molar mass of from 500 g/mol to 3000 g/mol. These resins are typically prepared by alkali-catalyzed condensation of the corresponding oxo compounds in the presence of the ureas. Suitable ketone resins are derived in particular from cycloaliphatic ketones A11 having preferably from 5 to 12 carbon atoms in the ring, such as cyclohexanone or its alkyl derivatives, where it is possible for the cycloaliphatic ring to carry one or more alkyl groups, the alkyl groups independently of one another having from 1 to 8 carbon atoms, and these may be selected in particular from methylcyclohexanone, 2-ethylhexylcyclohexanone, and tert.-butylcyclohexanone. The resins can be obtained from these ketones or from mixtures thereof in accordance with the known methods (see Ullmann, 4th ed., 12, p. 551, 1976). Further suitable resins A are obtained by condensation of aldehydes A12 in the presence of urea, substituted ureas or derivatives thereof as per A2. In this context the aliphatic aldehydes A12 are preferably linear or branched and have from 2 to 20, preferably from 4 to 10, carbon atoms. Condensation products of the aldehydes themselves, such as aldol or crotonaldehyde, can also be condensed in a mixture with the aldehydes. In the preparation of cocondensates of aldehydes and ketones with ureas it is also possible to use formaldehyde as a component A12, in which case the mass fraction of formaldehyde in the mixture of the aldehydes ought not to be more than 30%. Particular preference is given to condensates of isobutyraldehyde, formaldehyde, and urea (cf. Ullmann, Enzyklopadie der technischen Chemie, 5th ed., volume A23, p. 104 f.). Condensates in which formaldehyde is used as the sole oxo compound are not suitable for the invention.

The hydroxyl number is defined in accordance with DIN EN ISO 4629 as the ratio of that mass m_{KOH} of potassium hydroxide which has exactly the same number of hydroxyl groups as a sample under analysis to the mass m_{B} of that sample (mass of the solid in the sample in the case of solutions or dispersions); its customary unit is “mg/g”.

The polyfunctional isocyanates B are preferably selected from (cyclo)aliphatic isocyanates B1, mixed aliphatic-aromatic isocyanates B2, and aromatic isocyanates B3, having on average at least 2 isocyanate groups per molecule. Preference here is given to those isocyanates which have not been modified by reaction with hydrophilic compounds. These isocyanates therefore contain less than 0.1 mol/mol of acid groups or basic groups or other hydrophilic units, derived in particular from oligooxyalkylene or polyoxyalkylene compounds, especially from oxyethylene compounds, in the molecule. Preferably this fraction is not more than 0.05 mol/mol, and with particular preference not more than 0.02 mol/mol.

Examples of suitable isocyanates are trimethylene diisocyanate, tetramethylene diisocyanate, pentamethylene diisocyanate, hexamethylene diisocyanate (HDI), 1,2-propylene diisocyanate, ethylethylene diisocyanate, 2,3-dimethylethylene diisocyanate, 1-methyltrimethylene diisocyanate, 1,3-cyclopentylene diisocyanate, 1,4-cyclohexylene diisocyanate, 1,2-cyclohexylene diisocyanate, 1,3-phenylene diisocyanate, 1,4-phenylene diisocyanate, 2,4-toluylene diisocyanate (TDI), 2,6-toluoylene diisocyanate (TDI), 4,4′-biphenylene diisocyanate, 1,5-naphthylene diisocyanate, 1,4-naphthylene diisocyanate, 1-isocyantomethyl-5-isocyanato-1,3,3-trimethylcyclohexane (IPDI), bis(4-isocyanato-cyclohexyl)methane (HMDI), 4,4′-diisocyanatodiphenyl ether, 2,3-bis(8-isocyanato-octyl)-4-octyl-5-hexylcyclohexene, the isomeric trimethylhexa-methylene diisocyanates, tetramethylxylylene diisocyanate (TMXDI), uretdiones and isocyanurates of the above diisocyanates, and allophanates and biurets derived from the above diisocyanates. Mixtures of such diisocyanates or polyisocyanates can likewise be employed. Particular preference is given to the diisocyanates, especially TDI, TMXDI, HDI, HMDI, and IPDI, and to their uretdiones, isocyanurates, allophanates, and biurets.

Suitable aliphatic acids C have in each case at least one isocyanate-reactive group such as hydroxyl groups, amino groups, mercapto groups or hydrazine groups, and also at least one acid group, preferably a carboxylic or sulfonic acid group. The molecules suitable as component C may also contain different kinds of such groups: for example, in the same molecule, an amino group, a hydroxyl group, and a carboxylic acid group, or a hydroxyl group, a carboxylic acid group, and a sulfonic acid group. It is preferred for the acid groups to be less reactive toward isocyanates than are the first-mentioned isocyanate-reactive groups. Preference is given in particular to aliphatic hydroxy carboxylic acids such as lactic acid, dimethylolpropionic acid, tartaric acid, uvic acid, glycolic acid, dihydroxysuccinic acid, and malic acid; amino acids such as glycine, alanine, ornithine, aspartic acid, taurine, hydroxy amino acids such as tyrosine or mercapto amino acids such as cysteine. Dimethylol-propionic acid is particularly preferred. The component C may also contain mixtures of two or more of the suitable compounds.

The polyethers of D, which contain aliphatic hydroxyl groups, have a number-average molar mass Mₙ of from 200 g/mol to 8000 g/mol and contain at least one hydroxyl group per molecule; the mass fraction of oxyethylene units in the polyether(poly)ol is typically at least 50%, preferably at least 80%. Suitable are polyoxyalkylene glycols such as polyoxyethylene glycol and its copolymers with polyoxypropylene units. It is also possible to use the singly etherified polyether (poly)ols, such as polyethylene glycol monomethyl ether or monoethyl ether. Preference is given to polyethylene glycols having (number-average) molar masses Mₙ of from 200 g/mol to 8000 g/mol and to their monomethyl ethers.

The resins ABCD of the invention are obtainable by reaction of components A and B at elevated temperature, preferably at from 30° C. to 200° C., preferably in the melt without addition of a solvent, although it is possible if desired to add a solvent E′ which is inert under the reaction conditions, in mass fractions of up to 20%, based on the sum of the masses of components A to D and of the solvent. The reaction is performed until the amount of unreacted isocyanate groups in the reaction mixture has reached a value of below 0.1 g/(100 g). Thereafter (further) solvent E is added; if compounds of C have been used, amines or aqueous ammonia can be added to effect at least partial neutralization. The amount of alkalis is chosen, where appropriate, such that at least half of the acid groups of the resin are neutralized. Preferably, however, complete neutralization is carried out.

The ratio of the mass of the solvents E and E′ to the mass of the resin ABCD is preferably from 1:9 to 9:1, in particular from 2:8 to 4:6. A mass fraction of the solvents in the solution of from approximately 10% to approximately 40% has proven particularly advantageous.

Solvents E′ used are those solvents which contain no groups that are reactive toward isocyanate groups. Preference is given to dialkyl ethers of ethylene glycol and its oligomers such as dimethoxyethane, diethylene glycol dimethyl and diethyl ether, diethylene and triethylene glycol diacetate, acetone, methyl ethyl ketone, and diethyl ketone.

The solvents E may also, in addition, contain groups which can react with isocyanates. Groups of this kind are preferably hydroxyl groups. Particular preference, in addition to the solvents specified in E′, is given to the monoalkyl ethers of ethylene glycol and its oligomers. Mention may be made here of, in particular, methoxyethanol, ethoxyethanol, and butoxyethanol, and the methyl, ethyl, and butyl ethers of diethylene and triethylene glycol, and also of higher oligomers.

For the application according to the invention, it is not necessary for these solvents to be removed; for example, the mass fraction of such solvents in the paste resin can be up to 20%, preferably up to 10%.

These resins can be used when producing pigment preparations for solvent-borne coating systems and as a result of their outstanding pigment wetting, particularly in the case of iron oxide pigments, result in fine distribution without reagglomeration. As compared with the unmodified aldehyde resins or ketone resins, which can of course likewise be employed in solvent-borne systems, the aldehyde resins and ketone resins modified in accordance with the invention are distinguished by the fact that, surprisingly, the compatibility and the pigment-binding capacity for pigments such as titanium dioxide or the aforementioned iron oxide pigments have been improved without detriment to the pigment-dispersing properties, which are known to be good, with respect to the organic pigments such as phthalocyanine pigments and quinacridone pigments.

The invention is elucidated in greater detail by the examples below, which do not, however, restrict its scope. In the examples below, as in the text above, all figures with the unit “%” denote mass fractions (ratio of the mass of the compound in question to the mass of the mixture), unless indicated otherwise. “Parts” are always mass fractions. Concentration data in “%” are mass fractions of the dissolved compound in the solution (mass of the dissolved compound divided by the mass of the solution).

### EXAMPLES

### Example 1

### Urethane-Modified Paste Resins B1 and B2 Based on Aldehyde-Urea and/or Ketone-Urea Resins

### See Table 1

First of all an 80% strength solution of the aldehyde resin or ketone resin A in toluene was prepared and the moisture contained in the raw material was removed by brief azeotropic distillation at 115° C. to 120° C. Thereafter the reaction mass was cooled to 40° C. to 60° C. and the isocyanate component B was slowly added. The reaction was continued with stirring at 80° C. until the NCO content (amount of free isocyanate groups) remained constant. Thereafter component C and/or D were added. The hydroxy acid C was diluted in a suitable solvent in order to facilitate homogeneous distribution. The reaction was then carried out, with the temperature raised to from 70° C. to 100° C., until a mass fraction of unreacted isocyanate groups of less than 0.11% was attained. At that point the toluene was removed by distillation and the reaction mass was diluted by addition of a water-tolerant solvent (BG or MP) to a mass fraction of solids of from 60% to 80%. Thereafter the acid number of the resins was measured, after which the acid groups were neutralized at a temperature of from 60° C. to 70° C. At this point a pH of from 7.0 to 8.5 was set. In further experiments the preferred version was carried out: components A and C were introduced together as an initial charge right at the beginning, then homogenized, after which processing continued as indicated above.

“DMPA” denotes dimethylolpropionic acid; “PEG 750” stands for a polyoxyethylene glycol having a number-average molar mass of approximately 750 g/mol. “BuOEtOH” denotes 2-butoxyethanol. The neutralizing agents used were aqueous ammonia solution (“NH₄OH”) (25% NH₃ in aqueous solution), triethanolamine (“TEA”) and triethylamine (“Et₃N”) “HDI” denotes 1,6-diisocyanatohexane, “TDI” the commercially available mixture of tolylene diisocyanate, and “IPDI” isophorone diisocyanate. “Resin A” is a commercially available aldehyde resin based on acetaldehyde (®Laropal A 81, urea-aldehyde condensate; BASF AG) having an acid number of 1.5 mg/g, “resin K” is a ketone resin (®Laropal K80, urea-ketone condensate; BASF AG) based on cyclohexanone, having a hydroxyl number of from 110 mg/g to 150 mg/g. The further abbreviations have the following meanings: BG: butyl glycol, MP: methoxypropanol, NA: neutralizing agent, DMEA: dimethyl ethanolamine, TEA: triethylamine.

TABLE 1
Preparation of urethane-modified paste resins (masses of
components A, B, C and, D in g)

| | Resin B1 | Resin B2 |
|---|---|---|
| A | 1000 (resin A) | 1380 (resin K) |
| B | 261 (TDI) | 522 (TDI) |
| C | 134 (DMPA) | 134 (DMPA) |
| D | | 750 (PEG 750) |
| Acid number of reaction product | 40.1 | 20.1 |
| in mg/g | | |
| Mass of reaction product in g | 297 | 696 |
| Solvent | MP | BG |
| Neutralizing agent | TEA | DMEA |
| Mass fraction of solids in % | 65 | 65 |

The acid number is defined in accordance with DIN ISO 3682 as the ratio of that mass m_{KOH} of potassium hydroxide which is needed in order to neutralize a sample under analysis to the mass m_{B} of that sample (mass of the solid in the sample in the case of solutions or dispersions); its customary unit is “mg/g”.

The mass fraction of solids was determined as nonvolatile fraction in accordance with DIN EN ISO 3251 (initial mass 1 g, drying at 125° C. for 1 h).

### Example 2

### Preparation of Pigment Pastes

The paste resin B1 was then used to formulate the following pastes (masses of the substances employed):

Blue paste

| | |
|---|---|
| 130.00 g | B1 (65% strength solution) |
| 130.00 g | methoxypropanol |
| 40.60 g | ® Paliogenblau L 6480 |
| 12.20 g | ® Additol XL 255 |
| 312.80 g | |

White paste

| | |
|---|---|
| 40.00 g | B1 (65% strength solution) |
| 30.00 g | methoxypropanol |
| 115.00 g | ® Kronos 2310 (titanium dioxide pigment) |
| 2.20 g | ® Additol XL 255 |
| 187.00 g | |

® Paliogenblau L 6480 (BASF AG)
® Kronos 2310 (Kronos Titan)

### Example 3

### Pigmented Paints

These two pastes (pigment concentrates) are then used to pigment a solvent-borne clearcoat material based on the formulation F1, and an aqueous clearcoat material based on the formulation F2.

### F1:

Solvent-borne clearcoat material: (mass figures in g)

| | |
|---|---|
| 185.4 | ® Vialkyd AR 340/60SNA |
| 238.3 | ® Vialkyd AC 383/70SNB |
| 161 | ® Maprenal MF 514/60IB |
| 584.7 | |

® Vialkyd AR 340/60SNA, ® Vialkyd AC 383/70SNB, both commercially customary solvent-containing alkyd resins, (Cytec Surface Specialties Austria GmbH); ® Maprenal MF 514/60IB, melamine resin hardener in solution in isobutanol, Ineos Melamines GmbH
SNA: Solvent naphtha A, aromatics mixture, boiling range from 150° C. to 180° C.
SNB: Solvent naphtha B, aromatics mixture, boiling range from 180° C. to 210° C.

### F2:

Aqueous clearcoat material: (mass figures in g)

| | |
|---|---|
| 98.1 | ® Resydrol AY 586w/38WA |
| 0.4 | Ammonia |
| 1.1 | ® Additol VXW 4940/DI water = 1/1 (siccative) |
| 0.2 | ® Additol XL 297 (antiskinning agent) |
| 0.2 | ® Additol VXL 4930 (flow control agent) |
| 100 | |

® Resydrol AY 586w/38WA, water-dilutable, acrylic-modified alkyd resin, ® Additol VXW 4940 (mixing ratio stated as parts by mass), ® Additol XL 297, ® Additol VXL 4930 (Cytec Surface Specialties Austria GmbH); DI water: fully demineralized water.

These clearcoat materials were then pigmented with the pigment pastes of formulas L1 to L4 (figures for the masses of the compounds used in g). The pastes were incorporated using a paddle stirrer. In the case of the aqueous systems dimethylethanolamine (DMEA) was used to set a pH of from 8.0 to 8.5. Following application to a glass plate (150□m wet film thickness), measurements were made of the crosslinking and the gloss.

### L1:

Solvent-borne blue paint: (mass figures in g)

| | |
|---|---|
| 5 | Blue paste from Example 2 |
| 30 | Solvent-borne clearcoat material F1 |
| 10 | ® Additol XL 121 (flow control agent) |
| 200 | Solvent mixture* SNA/B = 7/3 |
| 37.1 | |

*SNA = Solvent naphtha A, aromatics mixture, boiling range from 150° C. to 180° C.; B = n-Butanol; parts by mass in the mixture

### L2:

Solvent-borne white paint: (mass figures in g)

| | |
|---|---|
| 10 | White paste from Example 2 |
| 30 | Solvent-borne clearcoat material F1 |
| 0.1 | ® Additol XL 121 (flow control agent) |
| 2 | Solvent mixture* SNA/B = 7/3 |
| 42.1 | |

Following the application of a 150□m wet film of each of paints L1 and L2 to glass, the applied paints were baked at 130° C. for 30 minutes.

### L3:

Aqueous blue paint: (mass figures in g)

| | | |
|---|---|---|
| 4 | Blue paste from Example 2 | |
| 40 | Aqueous clearcoat material F2 | |
| 0.3 | DMEA | |
| 44.30 | | pH value = 8.25 |

### L4:

Aqueous white paint: (mass figures in g)

| | | |
|---|---|---|
| 800 | White paste from Example 2 | |
| 40 | Aqueous clearcoat F2 | |
| 0.3 | DMEA | |
| 44.3 | | pH value = 8.21 |

After the application of a 150□m wet film of each of paints L3 and L4 to glass, the gloss of the paint films was measured after 48 hours of air drying at room temperature (RT; 23° C.). The gloss measurement was carried out using a gonioreflectometer (BYK) at an angle of 60° and 20° (for values see table below).

### Gloss Values:

| Paints | Gloss (60°) | Gloss (20°) |
|---|---|---|
| L1 | 94.50% | 83.20% |
| L2 | 98.20% | 86.00% |
| L3 | 92.60% | 86.60% |
| L4 | 92.70% | 83.30% |

These results of the gloss measurement show that using the resins of the invention it is possible to produce pigment pastes which give equally good results for solvent-borne paints (L1, L2) and for water-dilutable paints (L3, L4).

1. A method of use of urethane-modified hydrophilic resins ABCD as paste resins for solvent-borne coating materials, the resins ABCD being reaction products of mass fractions in the reaction mixture of
10% to 90% of aldehyde resins and/or ketone resins A having a hydroxyl number of from 20 mg/g to 300 mg/g, a softening temperature of from 60° C. to 140° C., and a number-average molar mass Mₙ of from 500 g/mol to 3000 g/mol,
5% to 30% of polyfunctional isocyanates B having an average of at least 2 isocyanate groups per molecule,
0% to 30% of aliphatic acids C having in each case at least one acid group and in each case at least one group which is able to react with isocyanates to form a urethane structure or urea structure, and
0% to 70% of an aliphatic polyether D having a number-average molar mass Mₙ of from 200 g/mol to 8000 g/mol and at least one hydroxyl group per molecule,
the sum of the mass fractions of reactants A to D always being 100%, and at least one of reactants C and D being used, comprising mixing the said paste resins with at least one pigment.

2. The method of use of claim 1, wherein the mass fraction of the aliphatic acids C in the reaction mixture is at least 2%.

3. The method of use of claim 1, wherein the mass fraction of the aliphatic polyethers D in the reaction mixture is at least 5%.

4. The method of use of claim 1, wherein the resins A are condensation products of (cycle) aliphatic oxo compounds A1 and unsubstituted or substituted ureas A2.

5. The method of use of claim 1, wherein the isocyanates B contain less than 0.1 mol/mol of hydrophilic groups selected from acid groups, basic groups, and oligooxyalkylene and polyoxyalkylene groups.

6. The method of use of claim 1, wherein aliphatic hydrocarboxylic acids are used as acid C.

7. The method of use of claim 1, wherein the resin ABCD is diluted with solvents E and E′, solvents useful as solvents E being any desired solvents, while the solvents E′ contain no groups which are reactive toward isocyanates, and the solvents E′ being added before or during the reaction, and E after the reaction, and the ratio of the sum of the mass of E and E′ to the mass of the resin ABCD being 9:1 to 1:9.

8. The method of use of claim 1, wherein the resins ABCD are dispersed with pigments.

9. The method of use of claim 8, wherein the resins ABCD are used in combination with iron oxide pigments.
